(19) United States
(12) Patent Application Publication
(10) Pub. No.: US 2018/0206534 A1
(43) Pub. Date: Jul. 26, 2018

(54) Shelf Stabilized Hops Product

(71) Applicant: PicoBrew, Inc., Seattle, WA (US)

(72) Inventor: James B. Mitchell, Seattle, WA (US)

(21) Appl. No.: 15/416,431

(22) Filed: Jan. 26, 2017

(51) Int. Cl. A23L 7/20; C12C 3/00

(52) U.S. Cl. CPC A23L 7/20; A23V 2002/00; C12C 3/00

(57) ABSTRACT

A shelf-stabilized form of hops may be produced by mixing hops with rice bran and magnesium oxide. The stabilized hops may be contained in a paper filter for use during brewing. The rice bran may act as a surfactant or emulsifier during the boil phase of the brewing process. The magnesium oxide may accelerate isomerization during boiling, and by keeping the ingredients in a paper filter container, the magnesium oxide may be in close contact with the hops during beer making. It is believed that the magnesium oxide or other metal salt may offset the degradation of alpha acids at room temperature by slowly isomerizing the alpha acids. A typical form of shelf-stabilized hops may contain rice bran at amounts of 25% or more by weight of hops, and magnesium oxide at 3% or more by weight of hops. The mixture may be ground and pelletized prior to being contained in a paper filter.

### BACKGROUND

Hops have been used for centuries for many different uses, including medicinal uses, food flavorings, as well as beer making. Beer making uses hops for three main uses: bittering, flavor, and aroma.

The alpha acids in hops are found in the resin glands of the hop plant. During beer production, the alpha acids isomerize into iso-alpha acids. Common alpha acids include humulone, adhumulone, cohumulone, posthumulone, and prehumulone. The most common iso-alpha acids are cis- and trans-isohumulone.

The oils in the hops produce flavors and aromas.

Typically, bittering hops may be added during a boil phase of beer making, while flavor hops and aroma hops may be added at the end of the boil phase. Hops added at the end of the boil phase may not be isomerized and may not contribute substantially to the bitterness of the beer.

In a typical beer brewing process, grain mashing consists of enzymatic reactions that convert starches in the grains to sugars. These sugars are washed off and a boil phase occurs. During the boil phase, hops may be added for bittering, flavoring, and aroma. After the boil phase, the resulting wort is then cooled and fermented with yeast to produce alcohol.

The bittering effects of hops are largely due to alpha acid extraction during the boil phase. Flavoring and aroma components of the hops are various oils and other volatiles that can be boiled off. Consequently, the flavoring and aroma hops are added late in the boil phase to prevent the desirable components from being boiled off.

### Summary

A shelf-stabilized form of hops may be produced by mixing hops with rice bran and magnesium oxide. The stabilized hops may be contained in a paper filter for use during brewing. The rice bran may act as a surfactant or emulsifier during the boil phase of the brewing process. The magnesium oxide may accelerate isomerization during boiling, and by keeping the ingredients in a paper filter container, the magnesium oxide may be in close contact with the hops during beer making. It is believed that the magnesium oxide or other metal salt may offset the degradation of alpha acids at room temperature by slowly isomerizing the alpha acids. A typical form of shelf-stabilized hops may contain rice bran at amounts of 25% or more by weight of hops, and magnesium oxide at 3% or more by weight of hops. The mixture may be ground and pelletized prior to being contained in a paper filter.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DETAILED DESCRIPTION

Shelf Stabilized Hops

Hops may be processed with rice bran and magnesium oxide to create a shelf-stabilized form that may have increased extraction during a beer making process. A pelletized version may be placed in filter paper containers and added to wort during the beer making process. The rice bran may act as an emulsifier/surfactant during brewing, which may aid in alpha acid extraction.

The magnesium oxide may slowly isomerize the alpha acids while sitting on the shelf, which may counteract the natural degradation of the hops. Additionally, the magnesium oxide, by being in close proximity to the hops while in the filter paper container, may increase alpha acid extraction during brewing.

During the beer making process, the stabilized hops may be placed in the boiling kettle in the filter paper containers. Because the magnesium oxide may be kept in close proximity to the hops while in the filter paper, the magnesium oxide may act as a process aid or catalyst to convert alpha acids into iso-alpha acids during the beer making process. In many cases, the magnesium oxide may remain in the filter paper, so that it may not adversely affect the final beer taste.

Magnesium oxide and other food-grade metal salts isomerize alpha acids at high temperatures, typically between 50 and 100 C. Such a reaction may occur at a much slower pace at room temperature, and the composition may produce a shelf-stabilized formula that may isomerize alpha acids at roughly the same rate as the alpha acids may degrade. When this isomerization occurs, the alpha acids may be preserved for later use in the beer brewing process.

Any food-grade metal salt may be used in place of the magnesium oxide described above. The metal salt is used to convey the isomerization of α-acids to iso-α-acids. The metal salt may be any from the group consisting of magnesium oxide, magnesium sulfate, magnesium chloride, calcium oxide, calcium chloride, sodium hydroxide, potassium hydroxide, sodium carbonate, calcium carbonate, and mixtures thereof.

The shelf-stabilized hops may be manufactured by a process of grinding untreated hops pellets to a powder. Rice bran and magnesium oxide may be added and mixed thoroughly. The resulting mixture may be formed into pellets.

The processed pellets may be placed in filter paper containers, such as a filter paper sachet or tea bag. In some cases, the filter paper containers may be sewn, glued, stapled, or otherwise mechanically sealed to keep the shelf-stabilized hops in the container during the beer brewing operations.

The filter paper containers may keep the ingredients in close proximity during the beer making process. Typically, the boil stage of a beer making process is very active and turbulent, with the beer being actively boiled. Such activity may cause the hops to disperse, although by keeping the hops, rice bran, and metal salts in close proximity, the active effects of the rice bran and metal salts may give greater extraction.

Some uses may not use a filter paper container and may permit the processed hops pellets to break apart and disperse during the boil sequence. In such cases, the effects of the rice bran and metal salts may be less effective due to dispersion in the wort, so the proportions of both ingredients may be higher than when a filter paper sachet or other container may be used.

The rice bran may aid extraction by acting as a surfactant or emulsifier. In this capacity, the rice bran may aid in the incorporation of the alpha acids into the beer during the boiling process.

The packaged containers may then be vacuum sealed in a protective packaging. Other packaging options may be to package the sachets in plastic packaging in an inert atmosphere.

The rice bran may be added at a ratio of 5%, 10%, 15%, 20%, 25%, 30%, 40%, or more by weight to the hops. The magnesium oxide may be added at a ratio of 0.5%, 1%, 2%, 2.5%, 3%, 3.5%, 4%, 5%, or more by weight of hops.

The shelf-stabilized sachets or packages of hops may be used by placing the entire filter paper container in the beer wort during manufacture. In a conventional boil kettle, one or more sachets may be added directly to the boil kettle. In a recirculating mash/boil system, the sachets may be introduced into a recirculating loop.

The shelf-stabilized sachets may be kept at room temperature for six months, nine months, a year, or longer. In several experiments, the sachets retained the same bittering strength over six months without degrading.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A stabilized hops product, said product comprising:
hops flowers;
rice bran; and
magnesium oxide.

2. The product of claim 1, said rice bran being between 5% and 40% by weight of said hops flowers.

3. The product of claim 2, said rice bran being between 10% and 30% by weight of said hops flowers.

4. The product of claim 3, said rice bran being between 15% and 25% by weight of said hops flowers.

5. The product of claim 4, said rice bran being between 20% and 25% by weight of said hops flowers.

6. The product of claim 1, said magnesium oxide being between 1% and 5% by weight of said hops flowers.

7. The product of claim 6, said magnesium oxide being between 2% and 4% by weight of said hops flowers.

8. The product of claim 7, said magnesium oxide being between 2.5% and 3.5% by weight of said hops flowers.

9. The product of claim 1, said hops product being in a pressed pellet form.

10. The product of claim 1, said hops flowers being processed into a powder prior to mixing with said rice bran.

11. The product of claim 1, said rice bran being between 5% and 40% by weight of said hops flowers and said magnesium oxide being between 1% and 5% by weight of said hops flowers.

12. The product of claim 11, said product being in a pressed pellet form.

13. A method of manufacturing a stabilized hops product, said method comprising:
grinding hops flowers to a powder;
adding rice bran and magnesium oxide to said powder to form a mixture; and
pressing said mixture to form pellets.

14. The method of claim 13, said rice bran being between 5% and 40% by weight of said hops flowers.

15. The method of claim 14, said rice bran being between 10% and 30% by weight of said hops flowers.

16. The method of claim 15, said rice bran being between 15% and 25% by weight of said hops flowers.

17. The method of claim 13, said magnesium oxide being between 1% and 5% by weight of said hops flowers.

18. The method of claim 17, said magnesium oxide being between 2% and 4% by weight of said hops flowers.

19. The method of claim 13, said hops flowers being in pelletized form prior to said grinding.

20. The method of claim 13 further comprising:
packaging said stabilized hops product in a filter bag.
